(19) United States
(12) Patent Application Publication
(10) Pub. No.: US 2014/0009381 A1
(43) Pub. Date: Jan. 9, 2014

(54) INFORMATION PROCESSING APPARATUS AND HANDWRITING RETRIEVE METHOD

(71) Applicant: KABUSHIKI KAISHA TOSHIBA, Tokyo (JP)

(72) Inventor: Qi ZHANG, Nishitama-gun (JP)

(73) Assignee: KABUSHIKI KAISHA TOSHIBA, Tokyo (JP)

(21) Appl. No.: 13/678,112

(22) Filed: Nov. 15, 2012

(30) Foreign Application Priority Data
Jul. 9, 2012 (JP) 2012-153901

(51) Int. Cl. G06F 17/30

(52) U.S. Cl. CPC G06F 17/30277
USPC 345/156

(57) ABSTRACT

According to one embodiment, an information processing apparatus includes an input module, and a display processor. The input module is configured to input, as a first retrieve key, first handwriting corresponding to a first handwritten object. The display processor is configured to output second handwritten object corresponding to second handwriting different from the first handwriting, the second handwriting determined according to the first handwriting, as a retrieve result corresponding to the first retrieve key.

### CROSS-REFERENCE TO RELATED APPLICATIONS

This application is based upon and claims the benefit of priority from Japanese Patent Application No. 2012-153901, filed Jul. 9, 2012, the entire contents of which are incorporated herein by reference.

### FIELD

Embodiments described herein relate generally to an information processing apparatus which is capable of processing a handwritten document, and a handwriting retrieve method which is used in the information processing apparatus.

### BACKGROUND

In recent years, various kinds of portable information processing apparatuses, such as a tablet, a PDA and a smartphone, have been developed. Most of these portable information processing apparatuses include touch-screen displays for facilitating input operations by users.

By touching a menu or an object, which is displayed on the touch-screen display, by a finger or the like, the user can instruct a portable information processing apparatus to execute a function which is associated with the menu or object.

However, most of existing information processing apparatuses with touch-screen displays are consumer products which are designed to enhance operability on various media data such as video and music, and are not necessarily suitable for use in a business situation such as a meeting, a business negotiation or product development. Thus, in business situations, paper-based pocket notebooks have still been widely used.

In business situations, there are cases that information processing apparatuses are expected to function as digital tools which can make easier the re-use of handwritten data such as documents which were created in the past.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an external appearance of an information processing apparatus according to an embodiment;

FIG. 2 is an exemplary view illustrating a configuration of a retrieve system including the information processing apparatus of the embodiment and a server;

FIG. 3 is a view illustrating an example of handwritten data which is handwritten on a touch-screen display of the information processing apparatus of the embodiment;

FIG. 4 is an exemplary view for explaining handwritten data which is stored in a storage medium by the information processing apparatus of the embodiment;

FIG. 5 is an exemplary block diagram illustrating a system configuration of the information processing apparatus of the embodiment;

FIG. 6 is an exemplary block diagram illustrating a functional configuration of a digital notebook application program which is executed by the information processing apparatus of the embodiment, and a functional configuration of the server;

FIG. 7 is an exemplary view for explaining handwriting characteristic information which is managed on a user-by-user basis by the server of FIG. 6;

FIG. 8 is an exemplary view illustrating a retrieve process operation which is executed by the information processing apparatus of the embodiment;

FIG. 9 is an exemplary block diagram illustrating another example of the functional configuration of the digital notebook application program which is executed by the information processing apparatus of the embodiment, and another example of the functional configuration of the server;

FIG. 10 is an exemplary view illustrating a retrieve process operation which is executed by the information processing apparatus of the embodiment or the server of FIG. 9;

FIG. 11 is an exemplary view illustrating a retrieve screen which is displayed by the information processing apparatus of the embodiment;

FIG. 12 is an exemplary view illustrating a retrieve result which is displayed on the retrieve screen of FIG. 11;

FIG. 13 is an exemplary view illustrating a state of a jump from the retrieve screen of FIG. 11 to a certain page;

FIG. 14 is an exemplary flowchart illustrating the procedure of a retrieve process which is executed by the information processing apparatus of the embodiment;

FIG. 15 is an exemplary flowchart illustrating a procedure of a handwriting conversion process which is executed by the information processing apparatus of the embodiment; and

FIG. 16 is an exemplary flowchart illustrating another procedure of the retrieve process which is executed by the information processing apparatus of the embodiment.

### DETAILED DESCRIPTION

Various embodiments will be described hereinafter with reference to the accompanying drawings.

In general, according to one embodiment, an information processing apparatus includes an input module, and a display processor. The input module is configured to input, as a first retrieve key, first handwriting corresponding to a first handwritten object. The display processor is configured to output second handwritten object corresponding to second handwriting different from the first handwriting, the second handwriting determined according to the first handwriting, as a retrieve result corresponding to the first retrieve key.

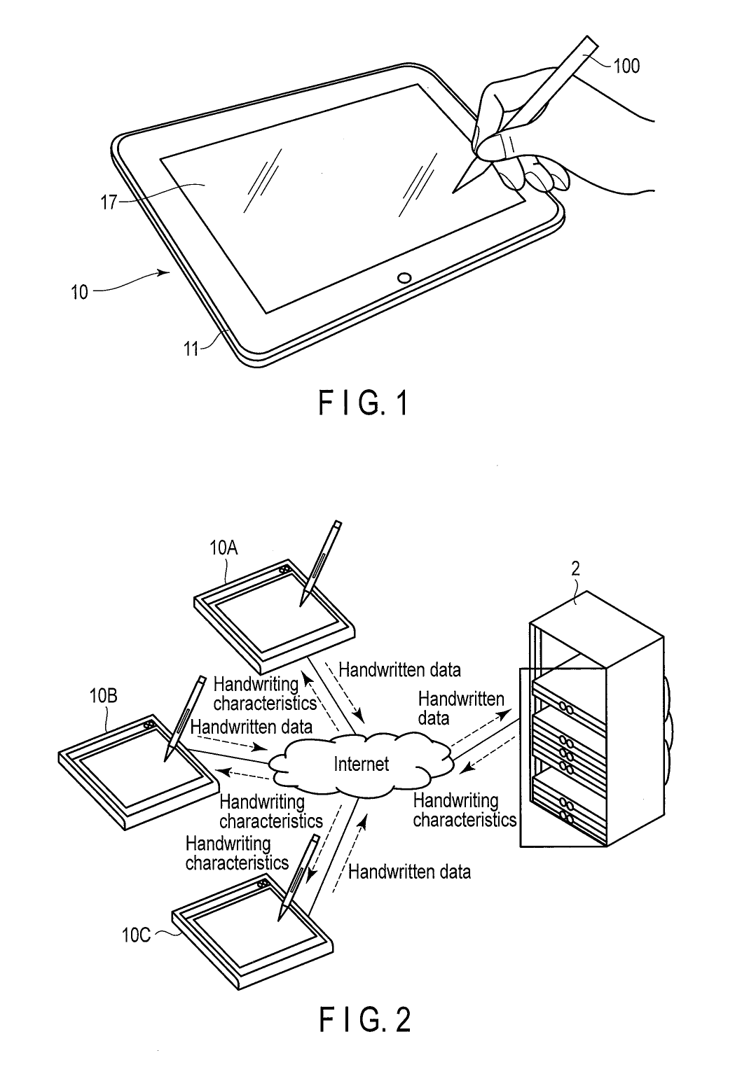

FIG. 1 is a perspective view illustrating an external appearance of an information processing apparatus according to an embodiment. The information processing apparatus is, for instance, a pen-based portable information processing apparatus which can execute a handwriting input by a pen or a finger. This information processing apparatus may be realized as a tablet computer, a notebook-type personal computer, a smartphone, a PDA, etc. In the description below, the case is assumed that this information processing apparatus is realized as a tablet computer 10. The tablet computer 10 is a portable electronic device which is also called “tablet” or “slate computer”. As shown in FIG. 1, the tablet computer 10 includes a main body 11 and a touch-screen display 17. The touch-screen display 17 is attached such that the touch-screen display 17 is laid over the top surface of the main body 11.

The main body 11 has a thin box-shaped housing. In the touch-screen display 17, a flat-panel display and a sensor, which is configured to detect a touch position of a pen or a finger on the screen of the flat-panel display, are assembled. The flat-panel display may be, for instance, a liquid crystal display (LCD). As the sensor, for example, use may be made of an electrostatic capacitance-type touch panel, or an electromagnetic induction-type digitizer. In the description below, the case is assumed that two kinds of sensors, namely a digitizer and a touch panel, are both assembled in the touch-screen display 17.

Each of the digitizer and the touch panel is provided in a manner to cover the screen of the flat-panel display. The touch-screen display 17 can detect not only a touch operation on the screen with use of a finger, but also a touch operation on the screen with use of a pen 100. The pen 100 may be, for instance, an electromagnetic-induction pen. The user can execute a handwriting operation on the touch-screen display 17 by using an external object (pen 100 or finger). During the handwriting operation, a locus of movement of the external object (pen 100 or finger) on the screen, that is, a stroke (handwriting) that is handwritten by the handwriting operation, is drawn in real time, and thereby each stroke (handwriting) is displayed on the screen. A locus of movement of the external object during a time in which the external object is in contact with the screen corresponds to one stroke. A set of many handwriting (strokes), which correspond to handwritten objects handwritten on the touch-screen display 17, such as handwritten characters, handwritten marks or handwritten graphics, constitutes handwritten data.

In the present embodiment, the handwritten data is stored in a storage medium not as image data but as handwriting information (time-series information) indicative of handwriting (strokes) of each handwritten object. The handwriting of each handwritten object is indicative of an order of strokes of a handwritten object, a shape of a handwritten object, etc. For example, the order of strokes of a handwritten character is indicative of an order in which a plurality of strokes, which are included in the handwritten character, were handwritten. Further, the order of strokes of the handwritten character is also indicative of a direction of writing of each stroke, that is, a direction in which each stroke was written.

Specifically, the handwriting information (time-series information) is indicative of an order in which a plurality of strokes were handwritten, and includes a plurality of stroke data corresponding to a plurality of strokes. In other words, the time-series information means a set of time-series stroke data corresponding to a plurality of strokes, respectively. Each stroke data corresponds to one stroke, and includes coordinate data series (time-series coordinates) corresponding to points on the locus of this stroke. Each stroke data is indicative of the characteristics of the stroke, such as a direction of writing of the stroke, the shape of the stroke and the inclination of the stroke. The order of arrangement of these stroke data in the time-series information corresponds to an order in which strokes were handwritten, that is, an order of strokes.

The tablet computer 10 can read out arbitrary existing time-series information from the storage medium, and can display, on the screen, handwritten data corresponding to this time-series information, that is, the loci corresponding to a plurality of handwriting (a plurality of strokes) indicated by this time-series information.

In this embodiment, the time-series information (handwritten data) may be managed as one page or plural pages. In this case, the time-series information (handwritten data) may be divided in units of an area which falls within one screen, and thereby a piece of time-series information, which falls within one screen, may be stored as one page (handwritten page). Alternatively, the size of one page may be made variable. In this case, since the size of a page can be increased to an area which is larger than the size of one screen, a handwritten document of an area larger than the size of the screen can be handled as one page. When one whole page cannot be displayed on the display at a time, this page may be reduced in size and displayed, or a display target part in the page may be moved by vertical and horizontal scroll.

Furthermore, the tablet computer 10 includes a handwriting retrieve function. In this handwriting retrieve function, codes indicative of an input character string are not input as a retrieve key. Instead, first handwriting itself (first strokes), which is indicative of a first handwritten object (a handwritten character, a handwritten mark, or a handwritten graphic) that is written by a handwriting operation on the touch-screen display 17, is input as a retrieve key, and existing handwritten data is retrieved by using the first handwriting. A second handwritten object having handwriting (strokes), the degree of similarity of which to the first handwriting (first strokes) that is input as the retrieve key is a reference value or more, is output to the touch-screen display 17 as a retrieve result corresponding to the above-described retrieve key.

In this manner, by using the handwriting itself of the handwritten object, a desired handwritten document can easily retrieved from previously created documents, and can be re-used.

To be more specific, in the handwriting retrieve, a handwritten object (handwritten character, handwritten mark, handwritten graphic) having handwriting, the degree of similarity of which to handwriting of a handwritten object (handwritten character, handwritten mark, handwritten graphic) designated as a retrieve key is a reference value or more, is retrieved from one or more retrieve-target handwritten data. This handwriting retrieve is online retrieval and, as described above, handwriting (strokes) of, e.g. a handwritten character, which was handwritten on the tablet computer 10, is used as a retrieve key.

In the handwriting retrieve, characteristics (order of strokes, shape of each stroke, inclination of each stroke, etc.) of handwriting of individual handwritten objects are extracted. Then, the degree of similarity is found between the characteristics of the handwriting of a handwritten object, which was designated as a retrieve key, and the characteristics of the handwriting of each handwritten object in one or more retrieve-target handwritten data. Thus, without depending on languages of handwritten characters, a handwritten character corresponding to a handwritten character designated as a retrieve key can be retrieved. Besides, not only handwritten characters, but also handwritten marks, handwritten graphics, etc. can be retrieved.

This handwriting retrieve technique does not depend on languages, as described above. However, since the manner of writing of characters, etc. vary from person to person. Thus, when handwriting of a third person (handwritten data of a third person) is to be retrieved, there may be a case in which an intended retrieve result cannot be obtained.

In addition, even in the case of the same person, it may be possible that the handwriting varies with the passing of time. Moreover, even when the same person handwrote the same character, there is a case in which the handwriting of a carefully handwritten character differs from the handwriting of a hastily handwritten character. Thus, it is possible that an intended retrieve result cannot be obtained, not only in the case of retrieving a third person's handwriting (third person's handwritten data), but also in the case of retrieving one's own handwritten data.

Thus, the handwriting retrieve function of this embodiment additionally includes a function of outputting a second handwritten object corresponding to second handwriting different from a first handwriting corresponding to a first handwritten object that is input as a first retrieve key, the second handwriting determined according to the first handwriting, as a retrieve result corresponding to the first retrieve key. The second handwritten object may be a handwritten object having handwriting, the degree of similarity of which to the second handwriting is a reference value or more. The second handwriting may be another handwriting which corresponds to the first handwriting and is different from the first handwriting. The first handwriting and the second handwriting may be different handwriting, which correspond to the same character handwritten by the same person. In addition, the first handwriting and the second handwriting may be different handwriting, which correspond to the same character handwritten by different persons.

The description below is mainly given of the case of retrieving a third person's handwritten data. When a third person's handwritten data is to be retrieved, first handwriting, which is input as a retrieve key, may automatically be converted to second handwriting which confirms to the handwriting characteristics of the author of this handwritten data.

Specifically, the handwriting (first handwriting) of a handwritten object, which is input as a retrieve key, is automatically be converted to another handwriting (second handwriting) which confirms to the handwriting characteristics of an author of retrieve-target handwritten data, and this second handwriting is used as a new retrieve key, thereby retrieving the above-described retrieve-target handwritten data. In other words, the handwriting, which is to be used as the retrieve key, is automatically changed from the first handwriting to the second handwriting.

In this manner, when a third person's handwritten data is to be retrieved, the first handwriting, which is input as a retrieve key, is automatically converted to the second handwriting which conforms to the handwriting characteristics of the author of this handwritten data. Thereby, even in the case of retrieving a third person's handwritten data, a desired retrieve result can be obtained, like the case of retrieving one's own handwritten data. The process of the above-described handwriting conversion may be executed by the tablet computer 10, or by another information processing apparatus (e.g. a server) which cooperates with the tablet computer 10.

FIG. 2 illustrates a retrieve system which is realized by using the tablet computer 10 of the present embodiment and cloud computing. This retrieve system includes a plurality of handwriting terminals (in this example, tablet computers 10A, 10B and 10C), and a server 2. The tablet computer 10A is a handwriting terminal which is used by a user A, the tablet computer 10B is a handwriting terminal which is used by a user B, and the tablet computer 100 is a handwriting terminal which is used by a user C.

Each of the tablet computers 10A, 10B and 100 is a handwriting terminal having the same function as the tablet computer 10 of the present embodiment, and includes the above-described handwriting retrieve function. Each of the tablet computers 10A, 10B and 100 is capable of communicating with the server 2 via the Internet.

The server 2 includes a storage device which stores handwritten data of the users of the tablet computers 10A, 10B and 100. The server 2 analyzes the handwritten data of each user, based on the stored handwritten data, thereby generating handwriting characteristic information indicative of the handwriting characteristics of each user. The handwriting characteristic information of each user is stored in the server 2.

Each of the tablet computers 10A, 10B and 100 can transmit handwritten data, which was created by a handwriting operation on this tablet computer, to the server 2 via the Internet (“upload”). In addition, each of the tablet computers 10A, 10B and 100 can receive handwritten data of an arbitrary user from the server 2 via the Internet (“download”). Each of the tablet computers 10A, 10B and 10C, when receiving from the server 2 the handwritten data which was uploaded from another terminal, can also receive from the server 2 the handwriting characteristic information of the user of this another terminal.

The case is now assumed that handwriting retrieve is executed on the tablet computer 10A. When handwritten data, which was created by a handwriting operation of the user A is to be retrieved, the handwriting (first handwriting) of a first handwritten object, which is input as a retrieve key by a handwriting operation of the user A, is used as a retrieve key as such. Then, a handwriting retrieve process is executed for retrieving, from the handwritten data, a second handwritten object having handwriting, the degree of similarity of which to the first handwriting is a reference value or more, and the second handwritten object is output to the touch-screen display 17 as a retrieve result corresponding to the above-described retrieve key.

Alternatively, the handwriting (first handwriting) of a first handwritten object, which is input as a retrieve key by a handwriting operation of the user A, is automatically converted in a background process to another handwriting (second handwriting) of the user A which corresponds to the first handwriting. Then, a handwriting retrieve process is executed for retrieving, from the handwritten data, a second handwritten object having handwriting, the degree of similarity of which to the second handwriting is a reference value or more, and the second handwritten object is output to the touch-screen display 17 as a retrieve result corresponding to the above-described retrieve key. Thereby, even when the handwriting of handwritten data, which was created by the user A in the past, is different from the present handwriting of the same user A, a desired retrieve result can be obtained.

On the other hand, when handwritten data, which was created by the user B, is to be retrieved, the handwriting (first handwriting) of a first handwritten object, which is input as a retrieve key by a handwriting operation of the user A, is automatically converted in a background process to another handwriting (second handwriting) which conforms to the handwriting characteristics of handwritten data created by the user B. Then, using at least this second handwriting as a retrieve key, a handwriting retrieve process for the handwritten data created by the user B is executed. In this case, in the handwriting retrieve process, a second handwritten object having handwriting, the degree of similarity of which to the second handwriting is a reference value or more, is retrieved from the handwritten data. Then, the second handwritten object is output to the touch-screen display 17 as a retrieve result corresponding to the above-described retrieve key. Thereby, even when a third person's handwritten data is to be retrieved, a desired retrieve result can be obtained.

The tablet computer 10A can execute the conversion process for converting the first handwriting to the second handwriting, by using at least one of the handwriting characteristic information of the user A and the handwriting characteristic information of the user B, which is received from the server 2. Incidentally, the above-described conversion process and the handwriting retrieve process may be executed by each terminal, or may be executed by the server 2. Besides, the conversion process may be executed by the server 2, and the handwriting retrieve process may be executed by each terminal.

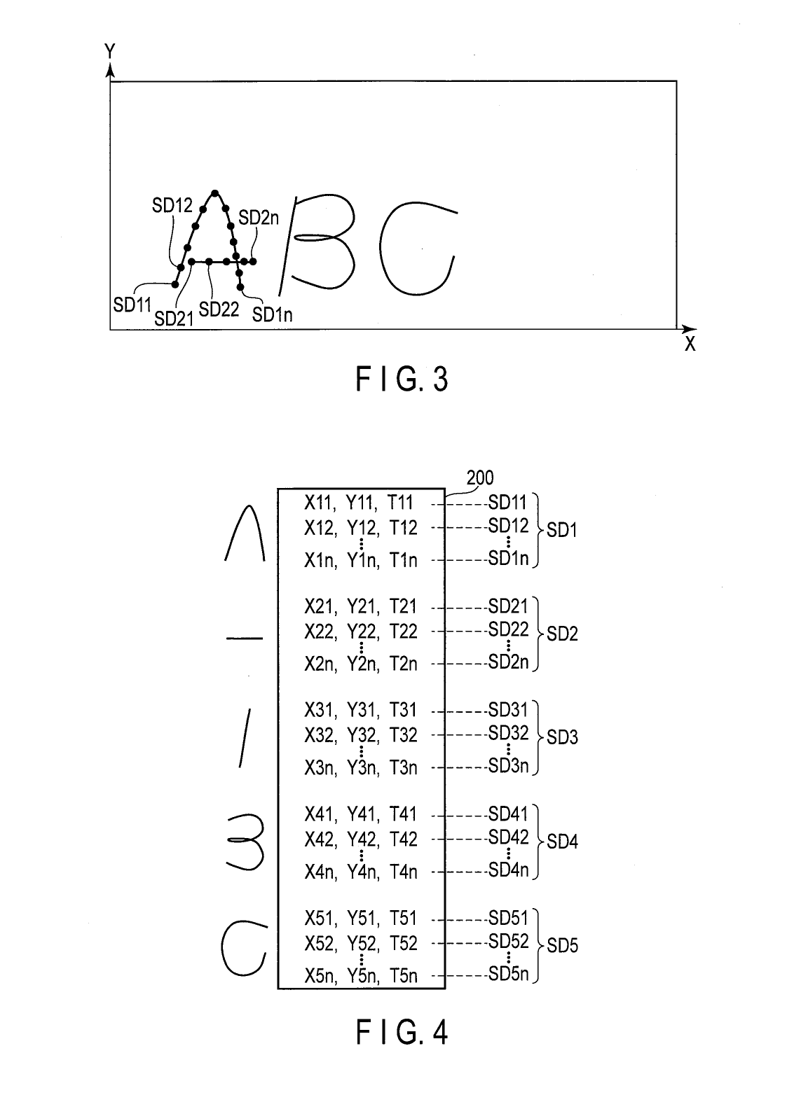

Next, referring to FIG. 3 and FIG. 4, a description is given of the relationship between an object (character, mark, graphic, table, etc.), which was handwritten by a user, and handwritten data (time-series information). FIG. 3 shows an example of a handwritten document (handwritten character string) which is handwritten on the touch-screen display 17 by using the pen 100 or the like.

In FIG. 3, the case is assumed that a handwritten character string “ABC” was handwritten in the order of “A”, “B” and “C”.

The handwriting of the handwritten character “A” is expressed by two strokes (a locus of “A” shape, a locus of “-” shape) which are handwritten by using the pen 100 or the like, that is, by two loci. The locus of the pen 100 of the first handwritten “̂” shape is sampled in real time, for example, at regular time intervals, and thereby time-series coordinates SD11, SD12, . . . , SD1n of the stroke of the “̂” shape are obtained. Similarly, the locus of the pen 100 of the next handwritten “-” shape is sampled in real time, for example, at regular time intervals, and thereby time-series coordinates SD21, SD22, . . . , SD2n of the stroke of the “-” shape are obtained.

The handwriting of the handwritten character “B” is expressed by two strokes which were handwritten by using the pen 100 or the like, that is, by two loci. The handwriting of the handwritten character “C” is expressed by one stroke which was handwritten by using the pen 100 or the like, that is, by one locus.

FIG. 4 illustrates handwritten data (time-series information) 200 corresponding to the handwritten character string of FIG. 3. The handwritten data (time-series information) 200 includes a plurality of stroke data SD1, SD2, . . . , SD5. In the time-series information 200, the stroke data SD1, SD2, . . . , SD5 are arranged in time series in the order of strokes, that is, in the order in which plural strokes were handwritten.

In the time-series information 200, the first two stroke data SD1 and SD2 are indicative of two strokes of the handwritten character “A”. The third and fourth stroke data SD3 and SD4 are indicative of two strokes which constitute the handwritten character “B”. The fifth stroke data SD5 is indicative of one stroke which constitutes the handwritten character “C”.

Each stroke data includes coordinate data series (time-series coordinates) corresponding to one stroke, that is, a plurality of coordinates corresponding to a plurality of points on the locus of one stroke. In each stroke data, the plural coordinates are arranged in time series in the order in which the stroke was written. For example, as regards handwritten character “A”, the stroke data SD1 includes coordinate data series (time-series coordinates) corresponding to the points on the locus of the stroke of the handwritten “̂” shape of the handwritten character “A”, that is, an n-number of coordinate data SD11, SD12, . . . , SD1n. The stroke data SD2 includes coordinate data series corresponding to the points on the locus of the stroke of the handwritten “-” shape of the handwritten character “A”, that is, an n-number of coordinate data SD21, SD22, . . . , SD2n. Incidentally, the number of coordinate data may differ between respective stroke data.

Each coordinate data is indicative of an X coordinate and a Y coordinate, which correspond to one point in the associated locus. For example, the coordinate data SD11 is indicative of an X coordinate (X11) and a Y coordinate (Y11) of the starting point of the stroke of the “̂” shape. The coordinate data SD1n is indicative of an X coordinate (X1n) and a Y coordinate (Y1n) of the end point of the stroke of the “̂” shape.

Further, each coordinate data may include time stamp information T corresponding to a time point at which a point corresponding to this coordinate data was handwritten. The time point at which the point was handwritten may be either an absolute time (e.g. year/month/day/hour/minute/second) or a relative time with reference to a certain time point. For example, an absolute time (e.g. year/month/day/hour/minute/second) at which a stroke began to be handwritten may be added as time stamp information to each stroke data, and furthermore a relative time indicative of a difference from the absolute time may be added as time stamp information T to each coordinate data in the stroke data.

In this manner, by using the time-series information in which the time stamp information T is added to each coordinate data, the temporal relationship between strokes can be more precisely expressed.

Moreover, information (Z) indicative of a pen stroke pressure may be added to each coordinate data.

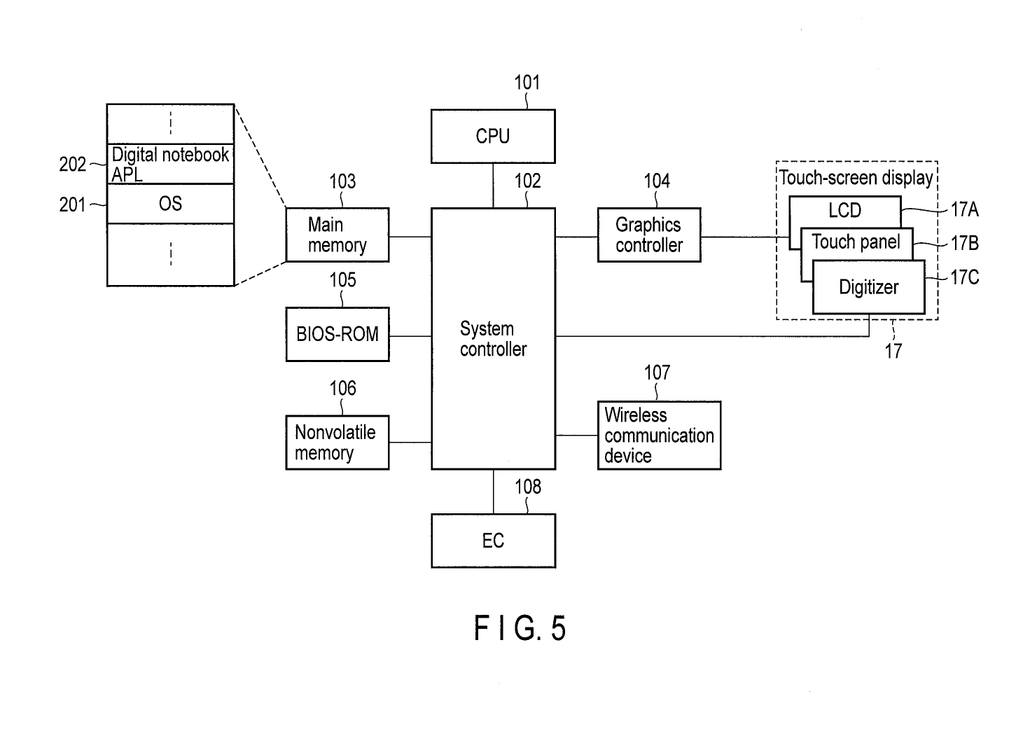

FIG. 5 shows a system configuration of the tablet computer 10.

As shown in FIG. 5, the tablet computer 10 includes a CPU 101, a system controller 102, a main memory 103, a graphics controller 105, a BIOS-ROM 105, a nonvolatile memory 106, a wireless communication device 107, and an embedded controller (EC) 108.

The CPU 101 is a processor configured to control the operations of various modules in the tablet computer 10. The CPU 101 executes various kinds of software, which are loaded from the nonvolatile memory 106 that is a storage device into the main memory 103. The software includes an operating system (OS) 201 and various application programs. The application programs include a digital notebook application program 202. The digital notebook application program 202 includes a function of creating and displaying the above-described handwritten data, a function of editing the handwritten data, and the above-described handwriting retrieve function.

The touch-screen display 17 is configured to detect the occurrence of events such as “touch”, “movement (slide)” and “release”. The “touch” is an event indicating that an external object has come in contact with the screen. The “move (slide)” is an event indicating that the position of contact of the external object has been moved while the external object is in contact with the screen. The “release” is an event indicating that the external object has been released from the screen. The digital notebook application program 202 receives an event “touch” or “move (slide)” which is generated by the touch-screen display 17, thereby detecting a handwriting input operation. The “touch” event includes coordinates of a contact position. The “move (slide)” event also includes coordinates of a contact position at a destination of movement. Thus, the digital notebook application program 202 can receive coordinate series, which correspond to the locus of movement of the contact position, from the touch-screen display 17.

The outline of a handwritten data creation process, which is executed by the digital notebook application program 202, is described.

If the user executes a handwriting input operation by using the pen 100, an event of “touch” or “move” occurs. Based on the event, the digital notebook application program 202 detects a locus of movement of the pen 100. If the locus of movement of the pen 100 has been detected, the digital notebook application program 202 displays the detected locus of movement of the pen 100 on the display. Further, the digital notebook application program 202 generates the above-described handwritten data (time-series information), based on the coordinate series corresponding to the detected locus of movement of the pen 100, and stores the handwritten data (time-series information) in the main memory 103 or nonvolatile memory 106.

In addition, the CPU 101 executes a basic input/output system (BIOS) which is stored in the BIOS-ROM 105. The BIOS is a program for hardware control.

The system controller 102 is a device which connects a local bus of the CPU 101 and various components. The system controller 102 includes a memory controller which access-controls the main memory 103. In addition, the system controller 102 includes a function of communicating with the graphics controller 104 via, e.g. a PCI EXPRESS serial bus.

The graphics controller 104 is a display controller which controls an LCD 17A that is used as a display monitor of the tablet computer 10. A display signal, which is generated by the graphics controller 104, is sent to the LCD 17A. The LCD 17A displays a screen image based on the display signal. A touch panel 17B and a digitizer 17C are disposed on the LCD 17A. The touch panel 17B is an electrostatic capacitance-type pointing device for executing an input on the screen of the LCD 17A. A contact position on the screen, which is touched by a finger, and a movement of the contact position, are detected by the touch panel 17B. The digitizer 17C is an electromagnetic induction-type pointing device for executing an input on the screen of the LCD 17A. A contact position on the screen, which is touched by the pen 100, and a movement of the contact position, are detected by the digitizer 17C.

The wireless communication device 107 is a device configured to execute wireless communication such as wireless LAN or 3G mobile communication. The wireless communication device 107 executes communication with the above-described server 2. As described above, in the case where both the above-described conversion process and handwriting retrieve process are executed by the server 2, the wireless communication device 107 functions as a communication device configured to transmit the above-described first handwriting as a retrieve key to the server 2, and to receive a retrieve result from the server 2.

In the case where both the above-described conversion process and handwriting retrieve process are executed by the tablet computer 10, the wireless communication device 107 functions as a communication device configured to receive from the server 2 at least one first handwriting characteristic information corresponding to the user (user A) of the tablet computer 10 and second handwriting characteristic information corresponding to the author (user B) of retrieve-target handwritten data.

The first handwriting characteristic information is information which indicates to which object identification code each of handwriting of the user A corresponds. The second handwriting characteristic information is information which indicates to which object identification code each of handwriting of the user B corresponds. The digital notebook application program 202 can execute the above-described conversion process, based on at least one of the first handwriting characteristic information and the second handwriting characteristic information. Furthermore, the digital notebook application program 202 can execute the above-described handwriting retrieve process by using the second handwriting, which is obtained by the conversion process.

The EC 108 is a one-chip microcomputer including an embedded controller for power management. The EC 108 includes a function of powering on or powering off the tablet computer 10 in accordance with an operation of a power button by the user.

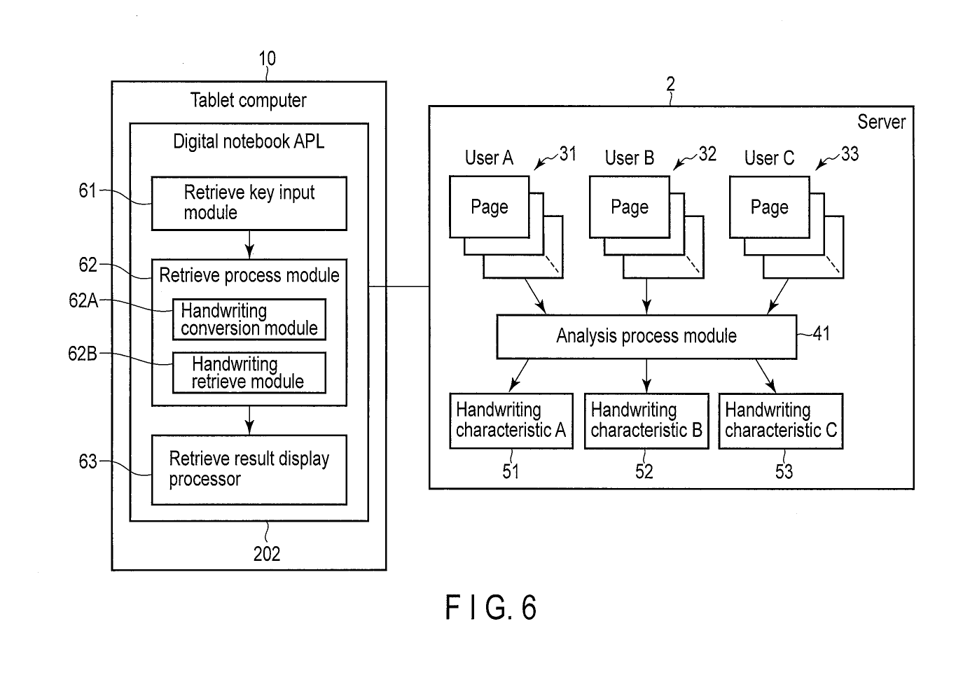

Next, referring to FIG. 6, a description is given of functional configurations of the digital notebook application program 202 and the server 2.

The digital notebook application program 202 includes at least a retrieve key input module 61 and a retrieve result display processor 63. The retrieve key input module 61 inputs, as a first retrieve key, first handwriting corresponding to a first handwritten object (a handwritten character, a handwritten mark, or a handwritten graphic). The first handwritten object may be written by a handwriting operation on the touch-screen display 17. The retrieve result display processor 63 is a display processor configured to output a second handwritten object corresponding to second handwriting different from the first handwriting, the second handwriting determined according to the first handwriting, as a retrieve result corresponding to the first retrieve key. For example, the retrieve result is obtained by executing the above-described conversion process and the above-described handwriting retrieve process by a retrieve processor 62 of the digital notebook application program 202 or by the server 2. Specifically, the retrieve result display processor 63 displays the retrieve result on the touch-screen display 17.

In the conversion process, based on handwriting characteristic information 51 of a user (e.g. user A) of the tablet computer 10 and handwriting characteristic information 52 of an author (e.g. user B) of retrieve-target handwritten data, first handwriting is converted to another handwriting (second handwriting) corresponding to the first handwriting, for example, second handwriting which conforms to the handwriting characteristics of the author (e.g. user B) of the retrieve-target handwritten data.

Alternatively, based on the handwriting characteristic information 52 of the author (e.g. user B) of retrieve-target handwritten data, the first handwriting is converted to another handwriting (second handwriting) corresponding to the first handwriting, for example, the second handwriting which conforms to the handwriting characteristics of the author (e.g. user B) of the retrieve-target handwritten data. In this case, by referring to the handwriting characteristic information 52 by using an object identification code that is obtained by character-recognizing the first handwriting, the handwriting of the user B, which corresponds to this object identification code, can be obtained from the handwriting characteristic information 52.

Alternatively, based on the handwriting characteristic information 51 of the user (e.g. user A) of the tablet computer 10, the first handwriting is converted to another handwriting (second handwriting) corresponding to the first handwriting, for example, another handwriting (second handwriting) which conforms to the handwriting characteristics of the user (e.g. user A) of the tablet computer 10. In this case, another handwriting, which is associated with the same object identification code as the object identification code corresponding to the first handwriting, is acquired from the handwriting characteristic information 51.

In the handwriting retrieve process, a handwritten object having handwriting, the degree of similarity of which to the second handwriting is a reference value or more, is retrieved from the retrieve-target handwritten data. Various methods can be used as the method of calculating the degree of similarity between handwritten objects, that is, the degree of similarity between handwriting of a handwritten object and handwriting of another handwritten object. For example, the coordinate series of each of handwriting (each stroke) may be treated as a vector. In this case, in order to calculate the degree of similarity between vectors which are targets of comparison, an inner product between the vectors which are targets of comparison may be calculated as the degree of similarity between the vectors which are targets of comparison. In addition, DP (Dynamic Programming) matching may be used as the method of calculating the degree of similarity between handwritten objects.

The retrieve result display processor 63 displays a retrieve result screen on the touch-screen display 17. A list of retrieve-target handwritten data each including a retrieved handwritten object may be displayed on the retrieve result screen. Alternatively, handwriting corresponding to each handwritten object in each retrieve-target handwritten data may be displayed on the touch-screen display 17, and handwriting, which corresponds to the retrieved handwritten object, may be displayed with emphasis.

FIG. 6 illustrates, by way of example, the case in which the digital notebook application program 202 includes the retrieve processor 62. The retrieve processor 62 includes a handwriting conversion module 62A and a handwriting retrieve module 62B.

The retrieve processor 62 receives from the server 2 the handwriting characteristic information 51 corresponding to the user (user A) of the tablet computer 10. In addition, the handwriting conversion module 62A receives from the server 2 retrieve-target handwritten data and the handwriting characteristic information 52 corresponding to the author (e.g. user B) of the retrieve-target handwritten data. In the meantime, the handwriting conversion module 62A may receive from the server 2 the retrieve-target handwritten data to which the handwriting characteristic information 52 is added.

Based on the handwriting characteristic information 51 and handwriting characteristic information 52, the handwriting conversion module 62A converts the first handwriting of the user A to the second handwriting of the user B. The handwriting retrieve module 62B searches the retrieve-target handwritten data by using the second handwriting, and retrieves from the retrieve-target handwritten data a handwritten object having handwriting, the degree of similarity of which to the second handwriting is a reference value or more. Incidentally, the handwriting retrieve module 62B can execute the above-described handwriting retrieve process by using not only the second handwriting but also the first handwriting. In this case, at first, first handwriting retrieve process may be executed for retrieving from the retrieve-target handwritten data a handwritten object having handwriting, the degree of similarity of which to the first handwriting is a reference value or more. Subsequently, a second handwriting retrieve process may be executed for retrieving from the retrieve-target handwritten data a handwritten object having handwriting, the degree of similarity of which to the second handwriting is a reference value or more. Then, a retrieve result, which is obtained by merging the handwriting retrieved by the first handwriting retrieve process and the handwriting retrieved by the second handwriting retrieve process, may be displayed on the touch-screen display 17.

The server 2 includes an analysis processor 41 for generating handwriting characteristic information 51, 52 and 53 corresponding to the user A, user B and user C. The analysis processor 41 extracts the handwriting characteristics of the respective users by analyzing handwritten data (pages) 31 of the user A, handwritten data (pages) 32 of the user B and handwritten data (pages) 33 of the user C, which are stored in the storage device of the server 2, thereby generating the above-described handwriting characteristic information 51, 52 and 53.

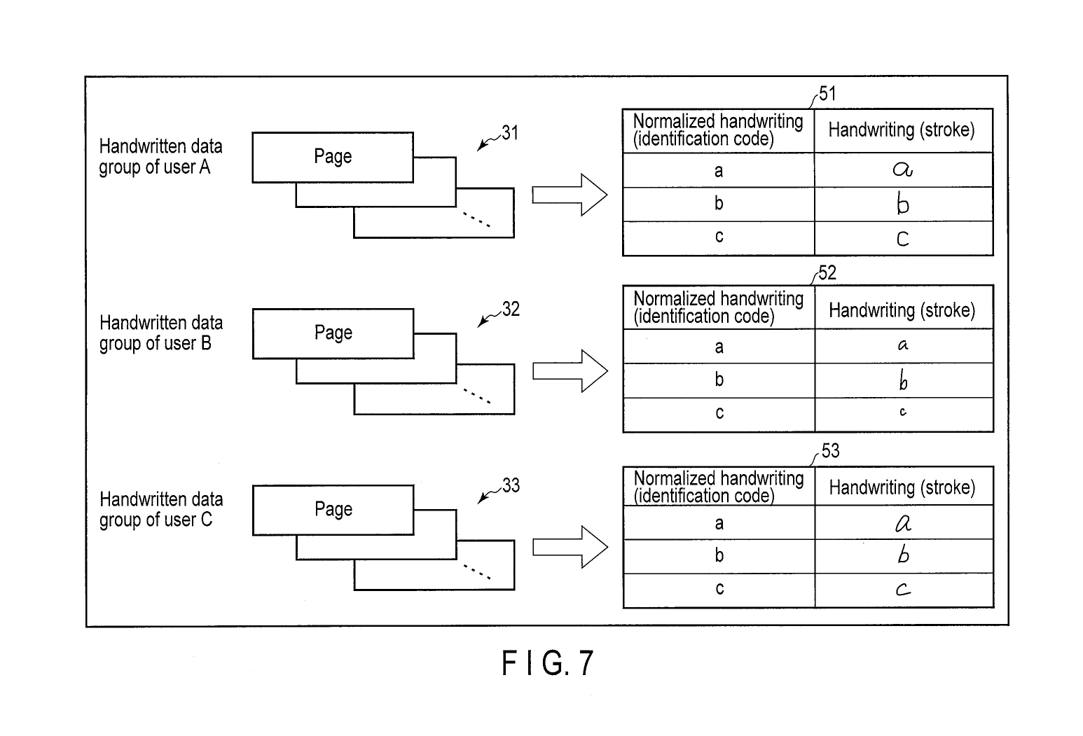

FIG. 7 illustrates an example of each handwriting characteristic information 51, 52, 53. The handwriting characteristic information 51 of the user A is obtained by analyzing a handwritten data group of the user A. In this analysis, use may be made of a character recognition process, a graphics recognition process, a context analysis process, etc. The handwriting characteristic information 51 is indicative of handwriting of the user A, which correspond to a plurality of normalized handwriting (identification codes). The identification code is an object identification code for uniquely identifying a handwritten object such as a handwritten character or a handwritten graphic. The object identification codes include, for instance, character codes, or other codes for identifying marks or graphics. The handwriting characteristic information 51 is composed of a table which is indicative of object identification codes corresponding to, e.g. character “a”, character “b”, character “c”, . . . , and handwriting of the user A, which correspond to each of the character “a”, character “b”, character “c”, . . . . Each of handwriting stored in the table is composed of one or more stroke data, which have been described with reference to FIG. 4. For example, stroke data indicative of the handwriting of a handwritten character of the user A, which is recognized as character “a” by the character recognition process, is stored in a field of the handwriting of the user A, which corresponds to character “a”. Incidentally, a plurality of different handwriting, which are associated with the same identification code, may be stored in the handwriting characteristic information 51.

The handwriting characteristic information 52 is indicative of handwriting of the user B, which correspond to a plurality of normalized handwriting (a plurality of object identification codes). The handwriting characteristic information 53 is indicative of handwriting of the user C, which correspond to a plurality of normalized handwriting (a plurality of object identification codes). In each of handwriting characteristic information 52, 53, a plurality of different handwriting, which are associated with the same identification code, may be stored.

Although the case of generating the handwriting characteristic information on a user-by-user basis has been described, it is possible to divide handwritten data, which were written by the same user, into a plurality of groups with different times of creation, for example, based on dates of creation of handwritten data, and to generate handwriting characteristic information with respect to each group. Thereby, handwriting, which has been written as a retrieve key by a certain user, can be converted to handwriting which confirms to this user's handwriting characteristics in the past, and handwritten data, which was written in the past by this user, can be retrieved by using the converted handwriting. There are cases where a person's handwriting characteristics vary with the passing of time. Thus, by converting the handwriting, which has been written as a retrieve key by a certain user, to the handwriting which confirms to this user's handwriting characteristics in the past, as described above, a desired retrieve result can easily be obtained even when handwritten data, which was created in the past by this user, is retrieved.

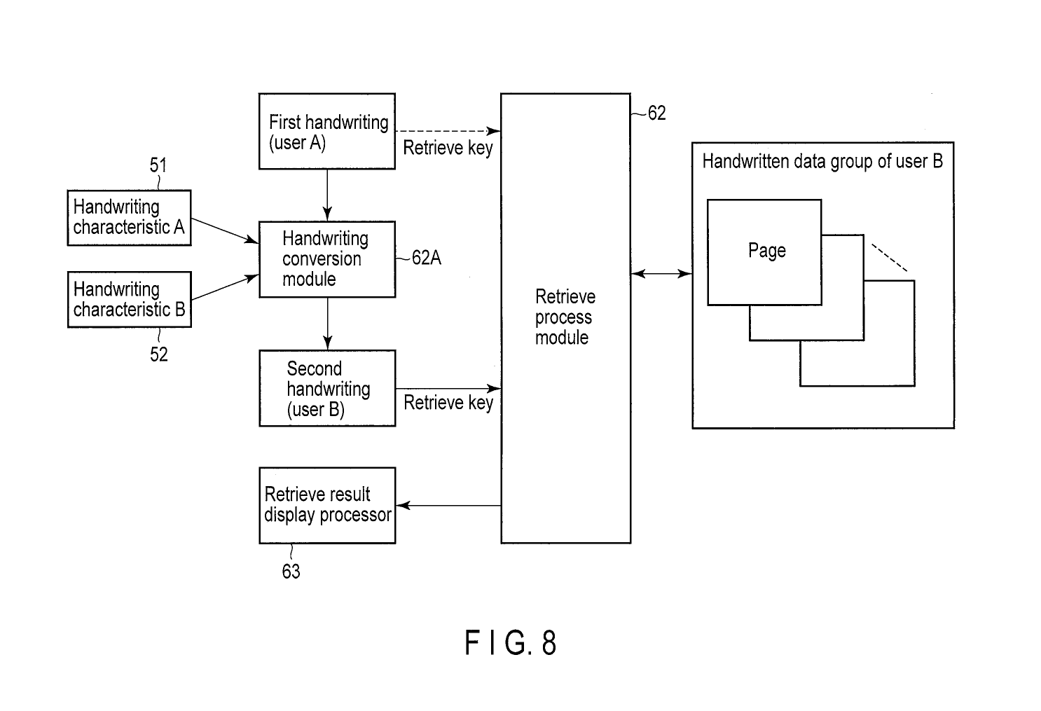

FIG. 8 illustrates a retrieve process operation which is executed by the tablet computer 10. The case is assumed that the user A of the tablet computer 10 retrieves a handwritten data group of the user B.

First handwriting, which is indicative of a handwritten object that has been written as a retrieve key by the user A, is sent to the handwriting conversion module 62A. The handwriting conversion module 62A acquires second handwriting of the user B which corresponds to the first handwriting, based on at least the handwriting characteristic information 52 of the user B, for example, based on the handwriting characteristic information 51 of the user A and the handwriting characteristic information 52 of the user B, or based on only the handwriting characteristic information 52 of the user B. For example, in the case where the handwriting of the handwritten object, which has been written as the retrieve key by the user A, is handwriting which is recognized as character “a”, the handwriting of the handwritten object of the user A is replaced with the handwriting of the user B which is recognized as character “a”.

The retrieve processor 62 retrieves the handwritten data group of the user B by using the second handwriting. Incidentally, the handwritten data group of the user B may be retrieved by using both the second handwriting and the first handwriting.

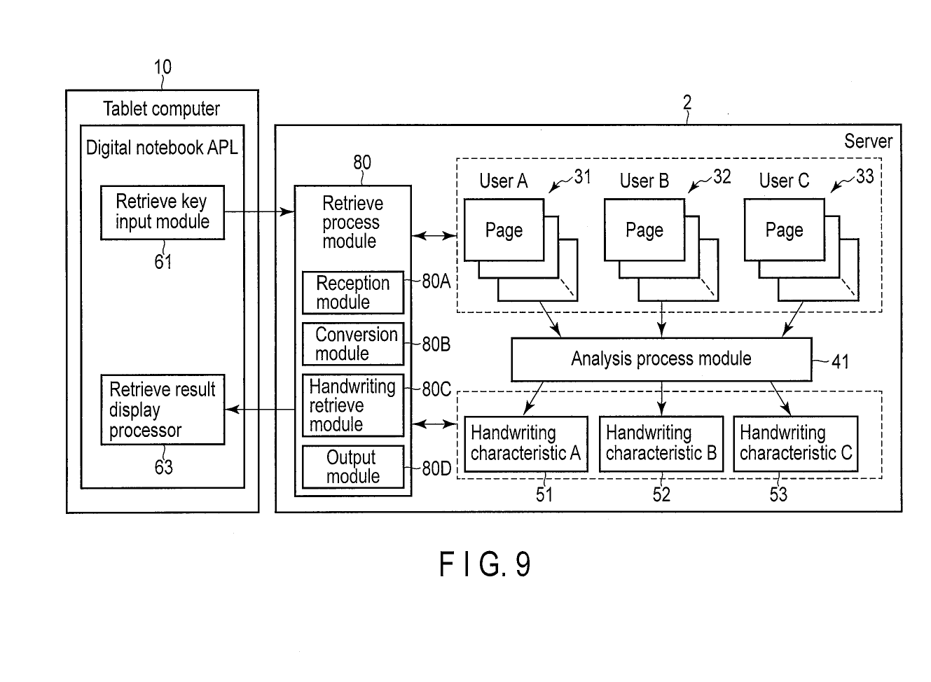

FIG. 9 illustrates another example of the functional configurations of the digital notebook application program 202 and the server 2.

In FIG. 9, the server 2 includes a retrieve processor 80. The above-described conversion process and handwriting retrieve process are executed by the retrieve processor 80 in the server 2.

The retrieve processor 80 includes a reception module 80A, a conversion module 80B, a handwriting retrieve module 80C and an output module 80D. The reception module 80A receives from an arbitrary terminal first handwriting, which has been written on the touch-screen display 17 of the tablet computer 10, as a retrieve key. The conversion module 80B converts the first handwriting to another handwriting (second handwriting) which corresponds to the first handwriting. In this conversion process, as described above, at least one of the handwriting characteristic information of the user A of the tablet computer 10 and the handwriting characteristic information of the author of the retrieve-target handwritten data is referred to. If the author of the retrieve-target handwritten data is the user A, only the handwriting characteristic information of the user A may be referred to. In addition, if the author of the retrieve-target handwritten data is the user B, both the handwriting characteristic information of the user A and the handwriting characteristic information of the user B may be referred to, or only the handwriting characteristic information of the user B may be referred to.

The handwriting retrieve module 80C executes a handwriting retrieve process for retrieving, from the retrieve-target handwritten data, handwriting, the degree of similarity of which to the second handwriting is a reference value or more. The output module 80D outputs a result of the handwriting retrieve process. For example, the output module 80D transmits a result of the handwriting retrieve process to the tablet computer 10.

The above description has been given of the case of converting the handwriting, which is used as the retrieve key, to the handwriting which conforms to the handwriting characteristics of the author of the retrieve-target handwritten data. Alternatively, the retrieve-target handwritten data may be converted to handwritten data which conforms to the handwriting characteristics of a person who executes retrieve.

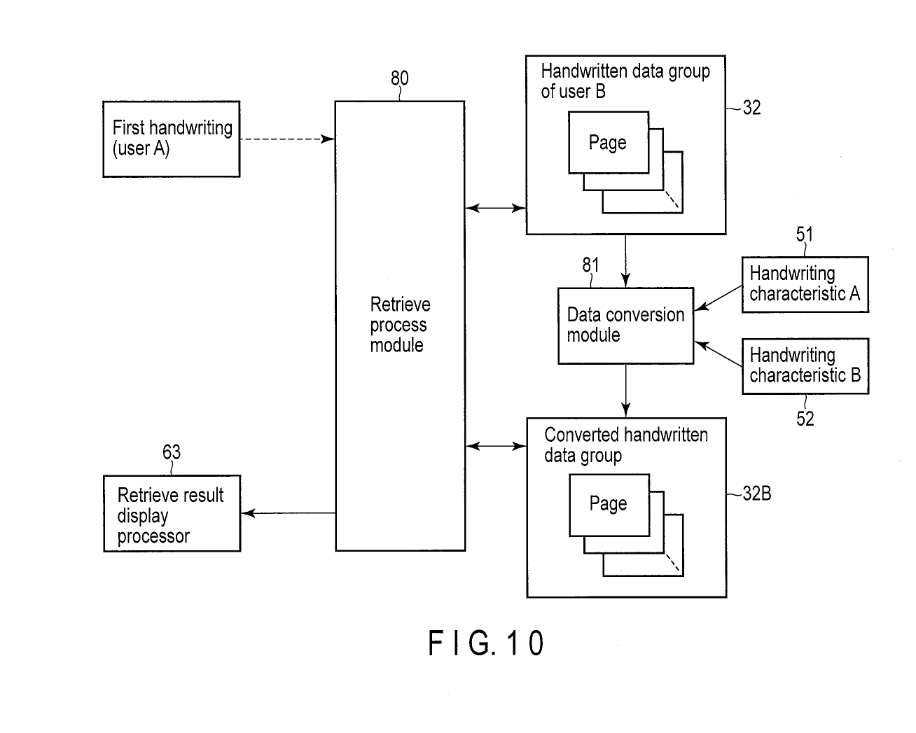

FIG. 10 illustrates a retrieve process operation including a handwritten data conversion process, which is executed by the tablet computer 10 or the server 2.

The case is now assumed that the user A of the tablet computer 10 retrieves the handwritten data group of the user B.

The data conversion module 81 is provided in the digital notebook application program 202 or the server 2. The data conversion module 81 converts each handwritten data 32 in the handwritten data group of the user B to handwritten data 32B which conforms to the handwriting characteristics of the user A. In this conversion process, based on the handwriting characteristic information 51 and 52, the handwriting of each handwritten object, which is included in the handwritten data of the user B, is replaced with handwriting which conforms to the handwriting characteristics of the user A. The handwriting (stroke data) of the user B, which corresponding to, e.g. character “a” included in the handwritten data of the user B, is replaced with handwriting (stroke data) of the user A which corresponds to character “a”. Similarly, the handwriting (stroke data) of the user B, which corresponds to, e.g. character “b” included in the handwritten data of the user B, is replaced with handwriting (stroke data) of the user A which corresponds to character “b”.

The retrieve processor 80 searches the handwritten data 32B by using first handwriting of a handwritten object which has been written as a retrieve key by the user A, and retrieves from the handwritten data 32B a handwritten object having handwriting, the degree of similarity of which to the first handwriting is a reference value or more. The retrieve result display processor 63 displays each handwritten object in the handwritten data 32 in a visually recognizable manner, in accordance with the position of each retrieved handwritten object in the handwritten data 32B.

In the handwriting retrieve in this embodiment, unlike text retrieve, there is no need to execute character recognition. Therefore, since there is no dependence on languages, handwritten data (handwritten pages) written in any language can be set to be a retrieve target. Moreover, graphics, etc. can be used as retrieve keys for the handwriting retrieve, and symbols, marks, etc., other than languages, can be used as retrieve keys for the handwriting retrieve.

FIG. 11 illustrates a handwriting retrieve screen 500 which is presented to the user by the digital notebook application program 202.

The handwriting retrieve screen 500 displays a retrieve key input area 501, a retrieve button 501A and a clear button 501B. The retrieve key input area 501 is an input area for writing a handwritten object (a handwritten character string or a handwritten graphic) which is to be set as the retrieval key. The retrieve button 501A is a button for instructing execution of handwriting retrieve process. The clear button 501B is a button for instructing deletion (clear) of a handwritten character string or graphic in the retrieve key input area 501.

The handwriting retrieve screen 500 further displays a plurality of retrieve-target handwritten data, that is, a plurality of handwritten page thumbnails 601. In the example of FIG. 9, nine handwritten page thumbnails 601 corresponding to nine handwritten pages are displayed.

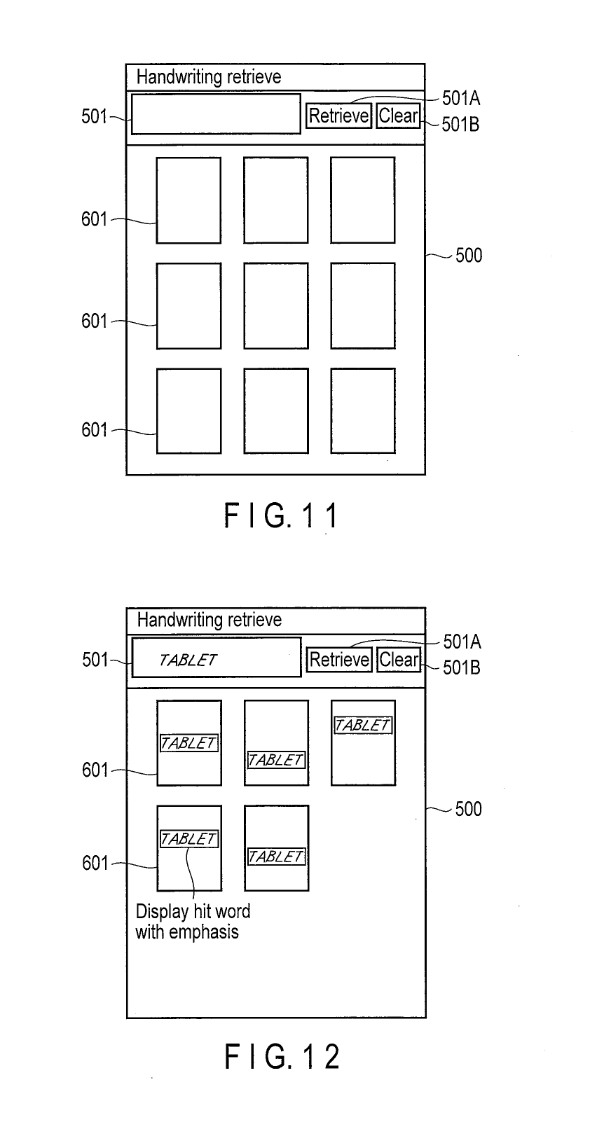

As shown in FIG. 12, when the retrieve button 501A has been pressed in the state in which a handwritten character string “TABLET” is input in the retrieve key input area 501, a handwriting retrieve process is started for retrieving a handwritten character string “TABLET” from each of the nine handwritten pages. Then, handwritten page thumbnails corresponding to some handwritten pages including the handwritten character string “TABLET” are displayed. FIG. 12 illustrates the case in which five handwritten pages of the nine handwritten pages have been retrieved as handwritten pages including the handwritten character string “TABLET”. Hit words, that is, the handwritten character strings “TABLET” in the five handwritten page thumbnails, are displayed with emphasis.

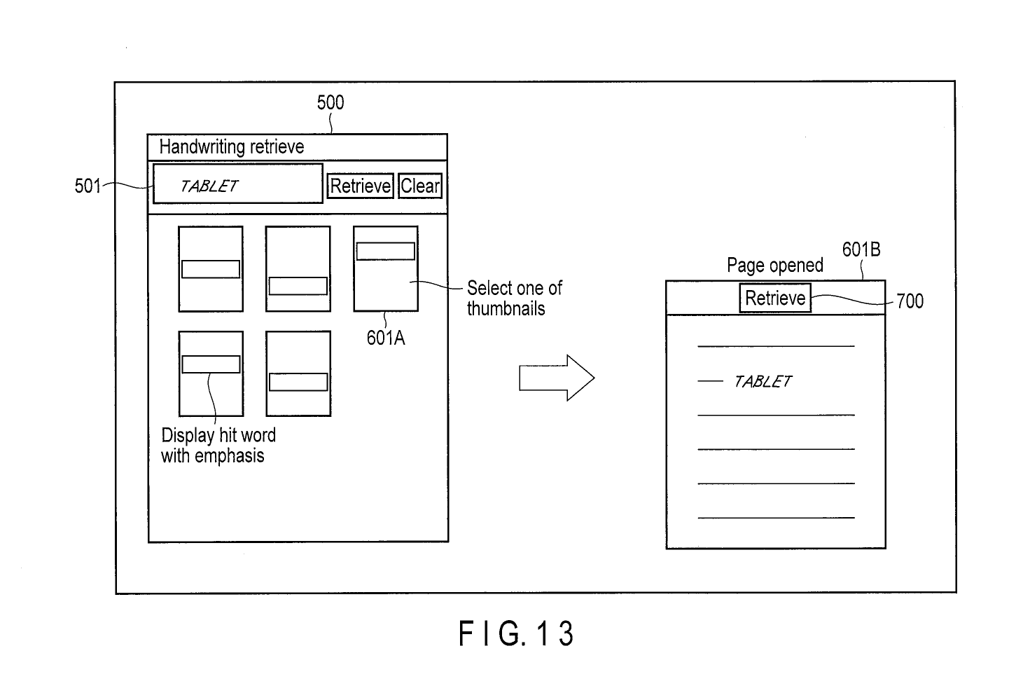

When one of the five retrieved handwritten page thumbnails has been selected by the user, as shown in FIG. 13, a handwritten page 601B corresponding to a selected handwritten page thumbnail 601A is displayed on the screen with the normal size. A retrieve button 700 is displayed on the handwritten page 601B. If the retrieve button 700 has been pressed by the user, the content of the display screen is restored to the retrieve screen, which is shown in the left part of FIG. 13.

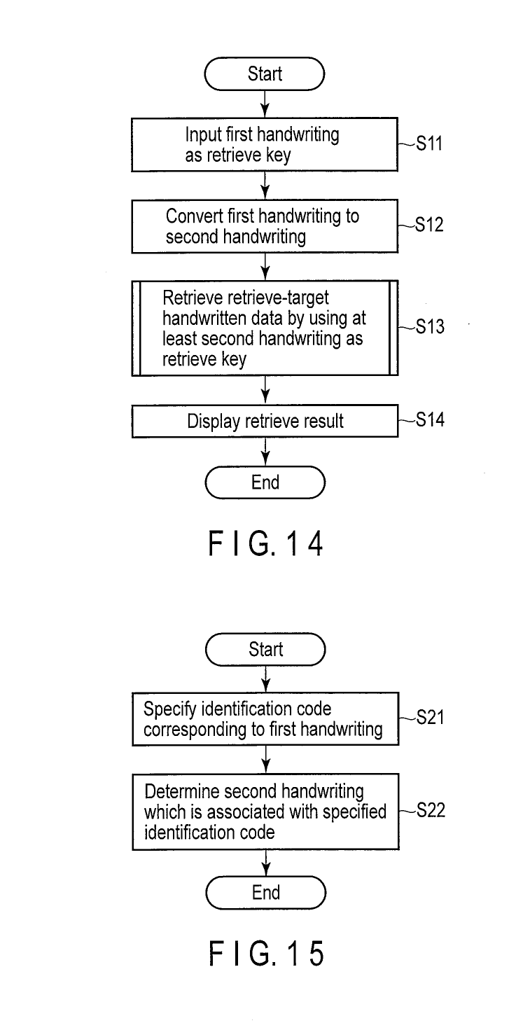

Next, referring to a flowchart of FIG. 14, the procedure of the retrieve process of the embodiment is described. A description is given of the case where the user A of the tablet computer 10 retrieves handwritten data. In addition, the case is assumed that the above-described conversion process and handwriting retrieve process are executed by the digital notebook application program 202 of the tablet computer 10.

The digital notebook application program 202 first executes a process of inputting, as a retrieve key, first handwriting indicative of a handwritten object, which has been written by the user A on the touch-screen display 17 (step S11). Then, the digital notebook application program 202 converts the first handwriting to second handwriting which corresponds to the first handwriting and is different from the first handwriting (step S12). In step S12, the second handwriting is determined according to the first handwriting, for example, based on the handwriting characteristic information 51 corresponding to the user A of the tablet computer 10. Alternatively, the second handwriting is determined according to the first handwriting, based on the handwriting characteristic information corresponding to the author of retrieve-target handwritten data. For example, if the author of retrieve-target handwritten data is the user B, the second handwriting is determined according to the first handwriting, based on at least the handwriting characteristic information of the user B.

Then, the digital notebook application program 202 retrieves the retrieval-target handwritten data by using at least the second handwriting (step S13). In step S13, the degree of similarity between the second handwriting and each handwritten object in the retrieve-target handwritten data is found. In this case, the characteristics of the second handwriting are first extracted. Further, the characteristics of the handwriting of each handwritten object in the retrieve-target handwritten data are extracted. Then, the degree of similarity between the second handwriting and each handwritten object in the retrieve-target handwritten data is found, based on a function of a difference between the characteristics of the second handwriting and the characteristics of the handwriting of each handwritten object in the retrieve-target handwritten data. Based on this degree of similarity, a second handwritten object having handwriting, the degree of similarity of which to the second handwriting is a reference value or more, is retrieved from the retrieve-target handwritten data. Then, the digital notebook application program 202 outputs a result of the retrieve process (handwriting retrieve process) of step S13, that is, the second handwritten object, to the touch-screen display 17 as a retrieve result corresponding to the above-described retrieve key, thereby displaying the retrieve result on the touch-screen display 17 (step S14).

In the meantime, in step S12, in the case where a handwritten object, which has been written by the user A, includes a plurality of handwritten characters, the handwriting of each handwritten character is converted to the handwriting which conforms to the handwriting characteristics of the author of the retrieve-target handwritten data. Then, using the plural handwriting after the conversion, the retrieve-target handwritten data is retrieved.

FIG. 15 illustrates the procedure of the conversion process (handwriting conversion process) which is executed in step S12 in FIG. 14. The case is assumed that the user A retrieves handwritten data of the user B. In addition, the case is assumed that both the handwriting characteristic information 51 and handwriting characteristic information 52 are used.

To start with, the digital notebook application program 202 specifies an object identification code corresponding to the first handwriting, by referring to the handwriting characteristic information 51 corresponding to the user A (step S21). Then, referring to the handwriting characteristic information 52 corresponding to the user B, the digital notebook application program 202 determines the handwriting of the user B, which is associated with the specified object identification code, to be the handwriting which is to be used as the retrieve key (step S22).

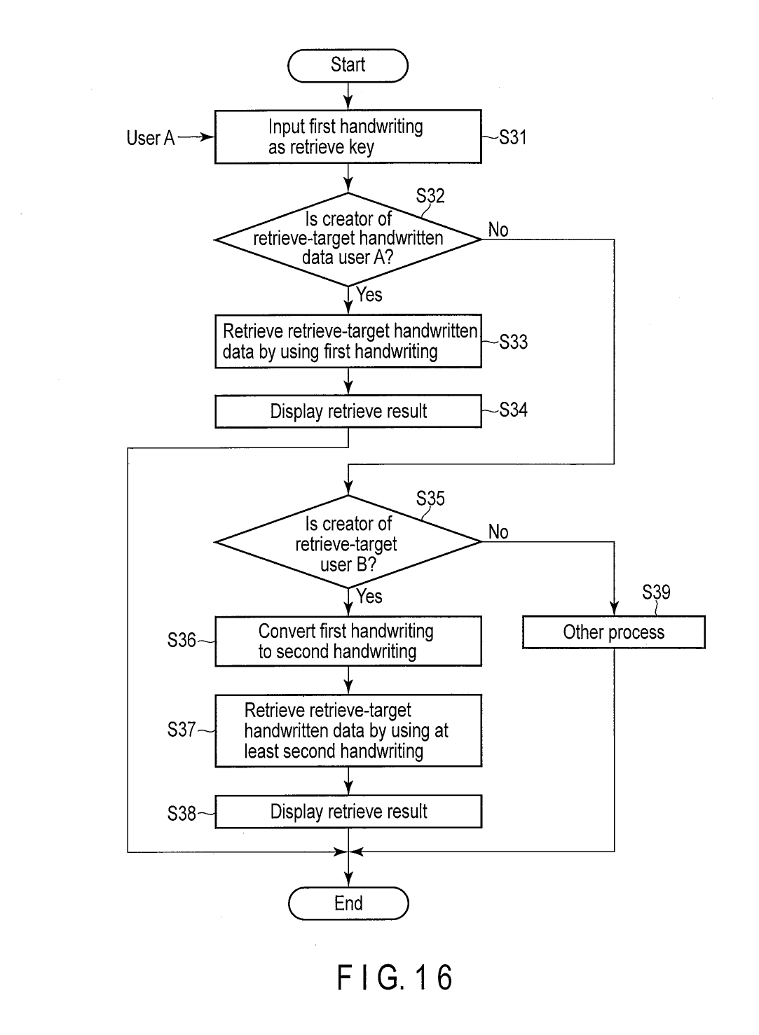

Next, referring to a flowchart of FIG. 16, an example of the procedure of the retrieve process of the embodiment is described. The case is assumed that the above-described conversion process and handwriting retrieve process are executed by the digital notebook application program 202 of the tablet computer 10.

The digital notebook application program 202 first executes a process of inputting, as a retrieve key, first handwriting indicative of a handwritten object, which is written by the user A on the touch-screen display 17 (step S31). Then, the digital notebook application program 202 determines whether the author (creator) of retrieve-target handwritten data is the user A or not (step S32). If the author (creator) of the retrieve-target handwritten data is the user A (YES in step S32), the digital notebook application program 202 retrieves the retrieval-target handwritten data by using the first handwriting (step S33), and displays a retrieval result on the touch-screen display 17 (step S34). Incidentally, referring to the handwriting characteristic information 51, the first handwriting may be converted to second handwriting which corresponds to the first handwriting and is different from the first handwriting, and the retrieve-target handwritten data may be retrieved by using the second handwriting.

On the other hand, if the author (creator) of the retrieve-target handwritten data is not the user A (NO in step S32), the digital notebook application program 202 determines whether the author (creator) of retrieve-target handwritten data is the user B or not (step S35). If the author (creator) of the retrieve-target handwritten data is the user B (YES in step S35), the digital notebook application program 202 converts the first handwriting to second handwriting which conforms to the handwriting characteristics of the user B, by using at least one of the handwriting characteristic information 51 corresponding to the user A and the handwriting characteristic information 52 corresponding to the user B (step S36). Then, the digital notebook application program 202 retrieves the retrieval-target handwritten data by using at least the second handwriting (step S37), and displays a retrieval result on the touch-screen display 17 (step S38).

If the author (creator) of the retrieve-target handwritten data is not the user B (NO in step S35), the digital notebook application program 202 advances to step S39. In step S39, the digital notebook application program 202 executes the above-described conversion process, based on the handwriting characteristic information 51 corresponding to the user A and handwriting characteristic information (e.g. handwriting characteristic information 53) corresponding to the author (e.g. user C) of the retrieve-target handwritten data. Then, the digital notebook application program 202 retrieves the retrieval-target handwritten data by using the second handwriting obtained by the conversion, and displays a retrieval result on the touch-screen display 17.

As has been described above, in the present embodiment, the first handwriting corresponding to the first handwritten object is input as a first retrieve key. The first handwritten object may be a handwritten object written by a handwriting operation on the touch-screen display 17. Then, a second handwritten object corresponding to second handwriting different from the first handwriting, the second handwriting determined according to the first handwriting, as a retrieve result corresponding to the first retrieve key. The second handwritten object may be a handwritten object having handwriting, the degree of similarity of which to the second handwriting is a reference value or more. Therefore, a desired handwritten object can easily be retrieved in the case where the handwriting of handwritten data, which was created by the user in the past, is different from the present handwriting of the same user, or in the case where a third person's handwritten data is retrieved.

Various processes on handwritten data in the embodiment can be realized by a computer program. Thus, the same advantageous effects as with the present embodiment can easily be obtained simply by installing the computer program into an ordinary computer with a touch-screen display through a computer-readable storage medium which stores the computer program, and executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
an input module configured to input, as a first retrieve key, first handwriting corresponding to a first handwritten object; and
a display processor configured to output a second handwritten object corresponding to second handwriting different from the first handwriting, the second handwriting determined according to the first handwriting, as a retrieve result corresponding to the first retrieve key.

2. The information processing apparatus of claim 1, wherein the second handwriting is determined according to the first handwriting, based on first handwriting characteristic information corresponding to a user of the information processing apparatus.

3. The information processing apparatus of claim 1, wherein the second handwriting is determined according to the first handwriting, based on second handwriting characteristic information corresponding to an author of handwritten data which is a retrieve target.

4. The information processing apparatus of claim 2, wherein the first handwriting characteristic information indicates to which of object identification codes each of handwriting of the user of the information processing apparatus corresponds.

5. The information processing apparatus of claim 3, wherein the second handwriting characteristic information indicates to which of object identification codes each of handwriting of the author corresponds.

6. The information processing apparatus of claim 1, further comprising a communication device configured to transmit the first handwriting to a server as the first retrieve key, and to receive the retrieve result corresponding to the first retrieve key from the server.

7. The information processing apparatus of claim 1, further comprising:
a communication device configured to receive from the server at least one of first handwriting characteristic information corresponding to a user of the information processing apparatus and second handwriting characteristic information corresponding to an author of handwritten data which is a retrieve target;
a conversion module configured to convert the first handwriting to the second handwriting, based on at least one of the first handwriting characteristic information and the second handwriting characteristic information; and
a handwriting retrieve module configured to retrieve, from the handwritten data that is the retrieve target, the second handwritten object having handwriting, the degree of similarity of which to the second handwriting is the reference value or more.

8. An information processing apparatus comprising:
an input module configured to input, as a first retrieve key, first handwriting corresponding to a first handwritten object; and
a communication device configured to transmit the first handwriting to a server as the first retrieve key, and to receive a retrieve result corresponding to the first retrieve key from the server.

9. The information processing apparatus of claim 8, wherein the retrieve result includes a second handwritten object corresponding to second handwriting different from the first handwriting, the second handwriting determined according to the first handwriting.

10. A handwriting retrieve method comprising:
inputting, as a first retrieve key, first handwriting corresponding to a first handwritten object; and
outputting a second handwritten object corresponding to second handwriting different from the first handwriting, the second handwriting determined according to the first handwriting, as a retrieve result corresponding to the first retrieve key.

11. A computer-readable, non-transitory storage medium having stored thereon a computer program which is executable by a computer, the computer program controlling the computer to execute functions of:
inputting, as a first retrieve key, first handwriting corresponding to a first handwritten object; and
outputting a second handwritten object corresponding to second handwriting different from the first handwriting, the second handwriting determined according to the first handwriting, as a retrieve result corresponding to the first retrieve key.
